(19) United States
(12) Patent Application Publication
(10) Pub. No.: US 2009/0055734 A1
(43) Pub. Date: Feb. 26, 2009

(54) Method and System of Displaying More Relevant Internet Ads

(76) Inventor: Brian Paul Channell, Redondo Beach, CA (US)

Correspondence Address: STATTLER - SUH PC, 60 SOUTH MARKET STREET, SUITE 480, SAN JOSE, CA, 95113, US

(21) Appl. No.: 11/842,595

(22) Filed: Aug. 21, 2007

(51) Int. Cl. G06F 15/00

(52) U.S. Cl. 715/273

(57) ABSTRACT

A method and system are provided for displaying more relevant ads to a user on the Internet. In one example, the method includes displaying a first content match module including a first ad set and a first keyword set having first keyword phrases, receiving a first keyword phrase selection of the first keyword phrases, and displaying a second content match module including a second keyword set, a second ad set targeted to the first keyword phrase selection, and a first content match module link.

### FIELD OF THE INVENTION

The present invention relates to advertising over the Internet. More particularly, the present invention relates to advertising over the Internet based on active user input.

### BACKGROUND OF THE INVENTION

Yahoo!® Content Match® ads enable an advertiser to broaden their reach beyond search results and attract more customers who are interested in what the advertiser is offering. Content Match® gives the advertiser a way to reach Internet users beyond search. Content Match® complements an advertiser's Sponsored Search campaign by displaying an advertiser's existing listings along with relevant articles, product reviews and more, thereby providing an additional source of targeted leads.

When a user goes to a site and views content pages, such as articles, Yahoo!® provides one or more relevant listings on the same page. Users may also be targeted based on their interests and actions. For example, a user who demonstrates an interest in sports related topics on one site may be provided with sports-related Content Match® listings on that site or on other Content Match® publisher sites. Yahoo!® and its Content Match® distribution partners may target users based on their aggregated interests and actions. So, a user who demonstrates an interest in a specific topic on one site may be shown Content Match® listings related to that topic when viewing content on that site or other sites within the same distribution network.

Whether the advertiser's advertising goal is to generate more sales, grow their lead volume or increase brand awareness, Content Match® provides cost-efficient, measurable results. Content Match® expands the reach of an advertiser's existing listings to popular Web sites, providing more targeted leads and increased visibility of their brand while saving them time and effort. Separate campaign management, including bidding, ad listing and tracking, lets the advertiser adjust their bids and measure performance independent of Sponsored Search to achieve maximum return on investment. The advertiser can control their advertising spend across their Content Match® campaigns with Yahoo!® Sponsored Search's Budgeting feature.

Content Match® ads, on a publisher's site, rely on understanding the context of any content on a page. Unfortunately, the understanding of the context on the page may not reflect the actual task the reader is wanting.

Also, the most common strategy when it comes to building Content Match® campaigns is to simply take your existing search campaigns and turn on Content Match®. The main reason why this idea does not work too well is the fact that not all search terms will work well in Content Match®. The vagaries of Content Match® will virtually guarantee that some of the words in your search set are very poor candidates for Content Match®-search terms that, for one reason or another, have a very high match rate to irrelevant or inappropriate content. That would not be so bad except that it is virtually impossible to figure out which search terms are the culprits.

When an advertiser gets Content Match® referrals, the advertiser knows what Ad Group the referrals are from. However, they do not know which search terms caused the search engine to think the page was relevant to the advertiser's ad. Nor is there any known way to find this out. So, the advertiser is stuck weeding out the garbage. That is fine until the next month when the search engine will likely stick the advertiser with another influx of bad sites and the advertiser has to repeat the process all over again, and again, and again.

### SUMMARY OF THE INVENTION

What is needed is an improved method having features for addressing the problems mentioned above and new features not yet discussed. Broadly speaking, the present invention fills these needs by providing a method and system of displaying more relevant ads to a user on the Internet. It should be appreciated that the present invention can be implemented in numerous ways, including as a method, a process, an apparatus, a system or a device. A device, as used herein, may be implemented in hardware, software or a combination thereof. Inventive embodiments of the present invention are summarized below.

In one embodiment, a method of displaying more relevant ads to a user on the Internet is provided. The method comprises displaying a first content match module including a first ad set and a first keyword set having first keyword phrases, receiving a first keyword phrase selection of the first keyword phrases, and displaying a second content match module including a second keyword set, a second ad set targeted to the first keyword phrase selection, and a first content match module link.

In another embodiment, an ad server for displaying more relevant ads to a user on the Internet is provided. The ad server comprises a content match module device configured to generate a first content match module including a first ad set and a first keyword set having first keyword phrases, and a receiver device configured to receive a first keyword phrase selection of the first keyword phrases, wherein the content match module device is further configured to generate a second content match module including a second keyword set, a second ad set targeted to the first keyword phrase selection, and a first content match module link.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a content match module, in accordance with an embodiment of the present invention;

FIG. 2 is a content match module that is the result of clicking keywords in the content match module of FIG. 1, in accordance with an embodiment of the present invention;

FIG. 3 is a content match module having a location text field, in accordance with an embodiment of the present invention;

FIG. 4 is a high-level view of an ad system, in accordance with an embodiment of the present invention; and

FIG. 5 is a method for displaying more relevant ads to a user, in accordance with a preferred embodiment of the present invention.

### DETAILED DESCRIPTION

An invention for displaying more relevant ads to a user on the Internet is disclosed. Numerous specific details are set forth in order to provide a thorough understanding of the present invention. It will be understood, however, to one skilled in the art, that the present invention may be practiced with other specific details.

The method of the present involves displaying Content Match® ads along with suggested keywords with the ads. When the user clicks the keywords, the ads change to reflect those keywords. This method involves receiving feedback from the user as to what the user is intending. The feedback will make the ads more relevant and useful to the user.

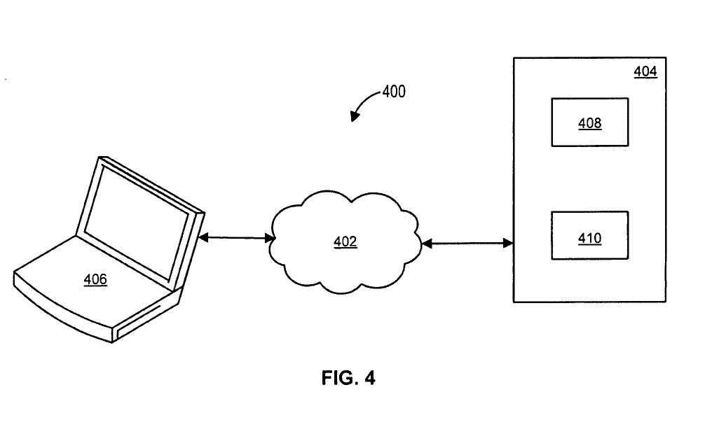

FIG. 4 is a high-level view of an ad system 400, in accordance with an embodiment of the present invention. The ad system 400 includes a user computer 406 coupled to an ad server 404 via a network 402. The network 402 is preferably the Internet. The user computer 406 may be a desktop, laptop, palmtop or any computing device where the Internet is accessible. The ad system 400 includes devices to carry out methods of displaying more relevant ads to a user. The ad server 404 includes a content match module device 408 configured to generate content match modules for display on the user computer 406. The ad server 404 also includes a receiver device 410 configured to receive user selections of links. These devices are further discussed with references to the figures.

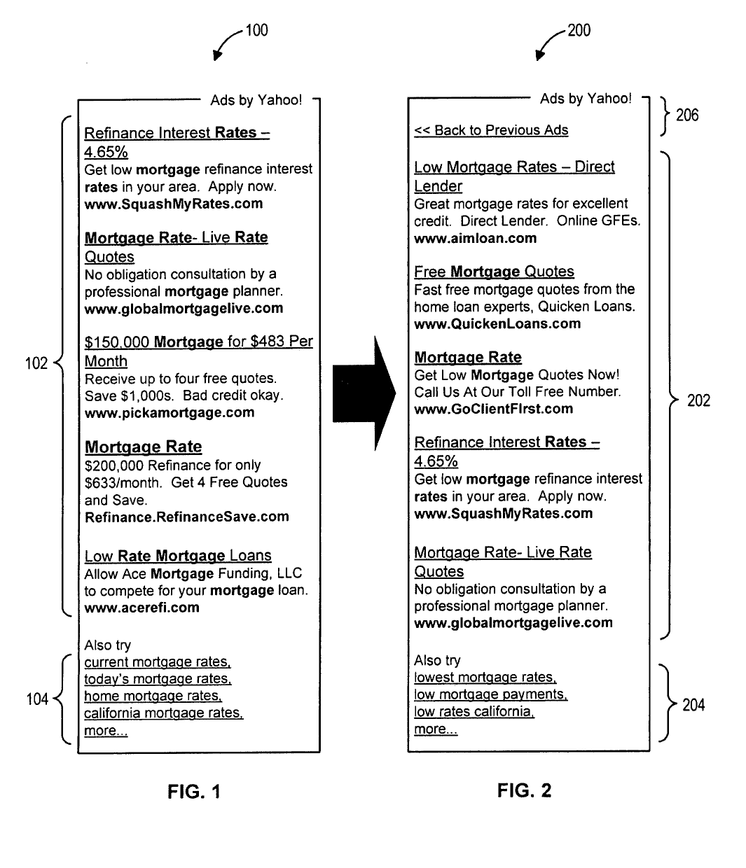

FIG. 1 is a content match module 100, in accordance with an embodiment of the present invention. The content match module device 408 of FIG. 4 is configured to generate the content match module 100 including an ad set 102 and a keyword set 104. The ad set 102 is preferable a set of Content Match® ads displayed in a typical way Content Match® ads are displayed in a content match module. The Content Match® ads preferably provide a link to the advertiser's website. The ad system may also display a URL with each Content Match ad.

The content match module 100 also includes a keyword set 104 that the ad system used to generate the ads of the ad set 102. The keyword set 104 includes keyword phrases on which a user may click. This keyword set may be derived at least partially from a search initiated by the user, the search involving the user inputting search terms into the user computer. The ad system receives the search terms provided by the user and suggests other key word phrases that may be relevant to the user.

The keyword set 104 includes the phrase “Also try” at the top. Alternatively, instead of the phrase “Also try”, the keywords set 104 may include the phrase “Searches related to . . . ” or another suitable phrase. This keyword set 104 includes 4 keyword phrases on which a user may click. Preferably, a keyword set displays between about 2 and 6 of these keyword phrases.

The advertising system may derive keyword phrases by a number of different filtering devices. In one example of filtering, the ad system uses a location filtering device that filters the keyword phrases based on location. Location filtering provides for more accuracy to a user's location. The ad system uses the user's location to generate a geo code for the user. In other words, a user views a page and located in a particular zip code derived from the user's IP address or a zip code provided by the site's publisher. The ad system then filters the keyword set 104 based on the user's location. A user's ad set 102 and keyword set 104 will be relevant to the user's location. For instance, a user in Nebraska may receive a keyword set 104 that includes the keyword phrase “Nebraska mortgage rates”. On the other hand, user in Los Angeles may receive a keyword set 104 that includes the keyword phrase “Los Angeles mortgage rates”.

In another example of filtering, the ad system uses a similar users filtering device that filters keyword phrases based on what friends or other group members previously selected while visiting the same page. The ad system operates in the background to collect the clicking behavior of other friends or group members. This clicking behavior provides information for filtering key phrases based on what appears to be relevant to other similar users.

In yet another example of filtering, the ad system uses a season filtering device that filters keyword phrases based on seasonality. Some keyword phrases may be used more than others during certain seasons. For instance, a keyword set 104 may include the keyword phrase “Tahoe snowboarding” alongside vacation ads displayed during the winter. On the other hand, a keyword set 104 may include the keyword phrase “Lake Tahoe sailing” alongside vacation ads displayed during the summer.

In still another example of filtering, the ad system uses a time filtering device that filters keyword phrases based on the time of the day. In a similar manner, the ad system may use a day filtering device that filters keyword phrases based on the day of the week. Some keyword phrases may be used more than others during certain times of the day or certain days of the week. For instance, a keyword set 104 may include the keyword phrase “pancake breakfast specials” alongside restaurant ads displayed during the morning. On the other hand, a keyword set 104 may include the keyword phrase “steak dinner specials” alongside restaurant ads displayed during the evening.

Generally, there are a number of other filtering devices that are not specifically discussed here but are still within the scope of the ad system.

FIG. 2 is a content match module 200 that is the result of clicking keywords in the content match module 100 of FIG. 1, in accordance with an embodiment of the present invention. The receiver device 410 of FIG. 4 is configured to receive clicks on links in the content match module. Once a user clicks on a keyword phrase of FIG. 1, the user is not taken away from the publisher's page itself. Rather, all of the previous ads in the content match module 100 of FIG. 1 are refreshed and replaced by a new content match module 200 including a new ad set 202 that is more targeted to the keyword phrase on which the user clicked. The content match module device 408 of FIG. 4 is configured to generate this content match module 200. The new ad set 202 may include entirely new ads or may include some or all of the previous ads from FIG. 1. This new ad set 202 is preferable a set of Content Match® ads displayed in a typical way Content Match® ads are displayed in a content match module. There may be an optional link 206 to return to the previous ad set 102 of FIG. 1 if the new ad set 202 does not meet the user's desires. This example shows the optional link 206 as “Back to Previous Ads”.

The advertising system has generated a new keyword set 204 which are refined phrases likely to be more suitable to the user's desires. This new keyword set 204 includes the phrase “Also try” at the top. Alternatively, instead of the phrase “Also try”, the new keyword set 204 may include the phrase “Searches related to . . . ” or another suitable phrase. This new keyword set 204 includes 3 refined keyword phrases on which a user may click. Preferably, a new keyword set displays between about 2 and 6 of these refined keyword phrases. The ad system may derive these keyword phrases by using filtering devices discussed with reference to FIG. 1.

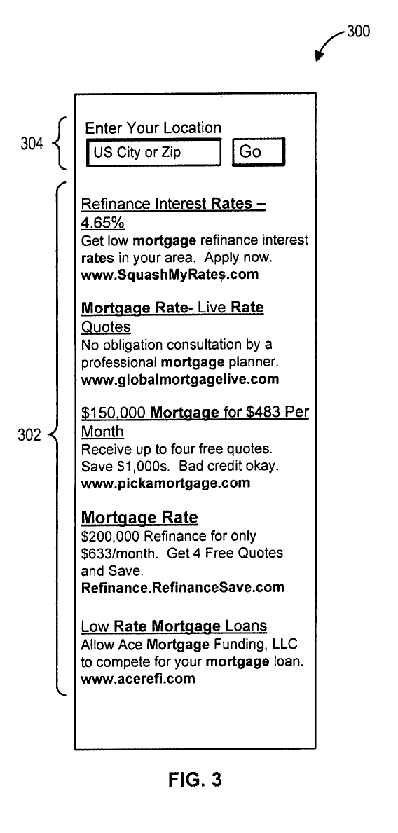

FIG. 3 is a content match module 300 having a location text field 306, in accordance with an embodiment of the present invention. The content match module 300 includes an ad set 302. The ad set 302 is preferable a set of Content Match® ads displayed in a typical way Content Match® ads are displayed in a content match module. The locations text field 306 allows a user to provide an identification of the user's location so that the ad system can better target local advertising. The ad system uses the location information to generate a new ad set including ads targeted to the location provided by the user.

In an alternative embodiment, the ad system learns from user selections over time, determines which keyword phrases are more popular, and then enhances the default ads to display ads more consistent with the popular phrases. In other words, the ad system learns to improve the accuracy and context of the ads displayed in the content match module. Preferably, the ad system learns from the site's publisher which phrases are more likely to be selected. This learning is directed more toward getting information from the site's publisher, instead of the individual user. For instance, if a publisher's site is all about mortgage rates in Los Angeles, the ad system will select advertisers in the Los Angeles area and filter keyword phrases to be related to mortgage rates in Los Angeles.

In another alternative embodiment, the ad system uses bumper ads in streaming video. For example, instead of using a static content match module, the ad system uses a bumper ad that is more suitable for streaming video.

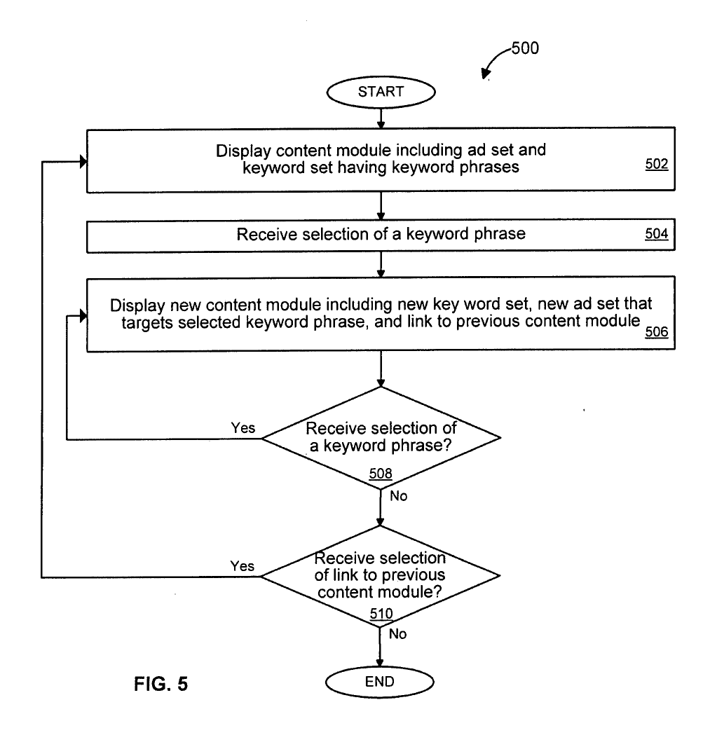

FIG. 5 is a method 500 for displaying more relevant ads to a user, in accordance with a preferred embodiment of the present invention. The method 500 starts in step 502 where the ad system displays a content match module including an ad set and a keyword set having keyword phrases. Next, the method 500 moves to stop 504 where the ad system receives a selection from the user of a keyword phrase from the key word set. The content match module then refreshes and changes. The method 500 moves to step 506 where the ad system displays a new content match module including a new keyword set, a new ad set that is more targeted to the selected keyword phrase, and a link to the previous content match module.

The method 500 then proceeds to decision operation 508 where it is determined whether the user clicks a new keyword phrase in the new content match module. If the user clicks a new keyword phrase, the method 500 returns to step 506 where the ad system displays another new content match module. However, if the user does not click one of the key phrases, the method 500 moves to decision operation 510 where it is determined if the user clicks the link to return to the previous content match module. If the user clicks the link to the previous content match module, the method 500 returns to step 502 where the ad system displays the previous content match module. However, if the user does not click the link to the previous content match module, the method 500 is at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to displaying a first content match module including a first ad set and a first keyword set having first keyword phrases, receiving a first keyword phrase selection of the first keyword phrases, and displaying a second content match module including a second keyword set, a second ad set targeted to the first keyword phrase selection, and a first content match module link, according to processes of the present invention.

### Advantages

The ad system serves more targeted ads to the user by having the user provide information, including feedback about what the user is looking for. The ad system provides a user active approach to Internet advertising, as opposed to a user passive approach. The ad system thereby provides better quality ads. Better quality advertising translates into better customers to the advertisers that utilize the ad system.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of displaying more relevant ads to a user on the Internet, the method comprising:
displaying a first content match module including a first ad set and a first keyword set having first keyword phrases;
receiving a first keyword phrase selection of the first keyword phrases; and
displaying a second content match module including a second keyword set, a second ad set targeted to the first keyword phrase selection, and a first content match module link.

2. The method of claim 1, further comprising:
receiving a second keyword phrase selection of the second keyword phrases; and
displaying a third content match module including a third keyword set, a third ad set targeted to the selected keyword phrase, and a second content match module link.

3. The method of claim 1, further comprising:
receiving a first content match module link selection; and
redisplaying the first content match module.

4. The method of claim 1, wherein the ad set includes a set of Content Match® ads.

5. The method of claim 1, further comprising deriving the first keyword set at least partially from a search initiated by the user.

6. The method of claim 1, further comprising applying a filtering device to derive the first keyword phrases.

7. The method of claim 6, wherein the filtering device is at least one of:
a location filtering device;
a similar uses filtering device;
a season filtering device;
a time filtering device; and
a day filtering device.

8. The method of claim 1, further comprising displaying a location text field configured to allow a user to provided identification of allocation of the user.

9. The method of claim 1, further comprising:
learning from user selections over time;
determining popular keyword phrases based on the learning of the user selection; and
and enhancing default ads to display ads that are more consistent with the popular keyword phrases.

10. The method of claim 9, wherein the learning includes receiving learned information from a publisher.

11. An ad server for displaying more relevant ads to a user on the Internet, the ad server comprising:
a content match module device configured to generate a first content match module including a first ad set and a first keyword set having first keyword phrases; and
a receiver device configured to receive a first keyword phrase selection of the first keyword phrases, wherein the content match module device is further configured to generate a second content match module including a second keyword set, a second ad set targeted to the first keyword phrase selection, and a first content match module link.

12. The ad server of claim 11, wherein:
the receiver device is further configured to receive a second keyword phrase selection of the second keyword phrases; and
the content match module device is further configured to generate a third content match module including a third keyword set, a third ad set targeted to the selected keyword phrase, and a second content match module link.

13. The ad server of claim 11, wherein:
the receiver device is further configured to receive a first content match module link selection; and
the content match module device if further configured regenerate the first content match module.

14. The ad server of claim 11, wherein the ad set includes a set of Content Match® ads.

15. The ad server of claim 11, wherein the ad server is configured to derive the first keyword set at least partially from a search initiated by the user.

16. The ad server of claim 11, further comprising a filtering device configured to derive the first keyword phrases.

17. The ad server of claim 16, wherein the filtering device is at least one of:
a location filtering device;
a similar uses filtering device;
a season filtering device;
a time filtering device; and
a day filtering device.

18. The ad server of claim 1, wherein the content match module device is configured to generate a location text field configured to allow a user to provided identification of a location of the user.

19. The ad server of claim 1, wherein the ad server is configured to:
learn from user selections over time;
determine popular keyword phrases based on the user selections over time; and
and enhance default ads to display ads that are more consistent with the popular keyword phrases.

20. The ad server of claim 19, wherein ad server is further configured to receive learned information from a publisher.

21. A computer readable medium carrying one or more instructions for displaying more relevant ads to a user on the Internet, wherein the one or more instructions, when executed by one or more processors, cause the one or more processors to perform the steps of:
displaying a first content match module including a first ad set and a first keyword set having first keyword phrases;
receiving a first keyword phrase selection of the first keyword phrases; and
displaying a second content match module including a second keyword set, a second ad set targeted to the first keyword phrase selection, and a first content match module link.

22. The computer readable medium of claim 21, wherein the one or more instructions, when executed by one or more processors, further cause the one or more processors to perform the steps of:
receiving a second keyword phrase selection of the second keyword phrases; and
displaying a third content match module including a third keyword set, a third ad set targeted to the selected keyword phrase, and a second content match module link.
